(19) United States
(12) Patent Application Publication
(10) Pub. No.: US 2006/0294091 A1
(43) Pub. Date: Dec. 28, 2006

(54) SYSTEM AND METHOD FOR GENERATING A PLAY-LIST

(76) Inventors: Kuan-Hong Hsieh, Shenzhen (CN); Xiao-Guang Li, Shenzhen (CN); Zai-An Pan, Shenzhen (CN); Bing Li, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,751

(22) Filed: Apr. 28, 2006

(30) Foreign Application Priority Data
Jun. 24, 2005 (CN) 200510035533.4

(51) Int. Cl. G06F 17/30; G11B 21/08; G06F 7/00

(52) U.S. Cl. 707/5; 369/30.08; 707/100

(57) ABSTRACT

The present invention relates to a method for generating a play-list of media files, includes the steps of: adjusting the current gain value in response to a control command for adjusting a current gain value during the course of a media file being played; obtaining a gain value having been adjusted; subtracting a referenced gain value by the adjusted gain value to obtain a gain difference; obtaining a weight value corresponding to the gain difference from a weight table; updating the weight value in a weight field of the media file; receiving a control command for generating a play-list; obtaining the weight value in the weight field in the weight field of each media file; and generating the play-list of the media files according to the weight values thereof. The present invention also provides a system for generating the play-list, making the play-list more tailored to a user's listening preferences.

### FIELD OF THE INVENTION

The present invention relates to a system and method for generating a media play-list, especially to a system and method for generating a play-list according to gain adjustments while media files are played.

### DESCRIPTION OF RELATED ART

The continuous development of new digital technology has helped made digital devices such as digital audio, digital picture, and other digital medias become popular among people. Media can be stored digitally in various data storage medium such as a hard disk, a compact disc (CD), and a network server. These data storage medium can then be used with portable devices such as a personal digital assistant (PDA), a media player, and/or an electronic-book reader (e-book). A current standard CD can store up to 140 average sized Moving Pictures Experts Group (MPEG) layer three (MP3) media files, whereas a media player with a data storage medium of 10 Gigabytes can store up to 2000 MP3 files. The cost of data storage medium has continued to decrease, allowing an average person to more easily acquire extra data storage capacity. Currently, a personal computer has a standard data storage capacity of 80 Gigabytes that can easily store up to 160,000 pieces of average sized MP3 files. As users continuously acquire their favorite media files, it is important that users can also quickly identify and select a desired media file from a humongous pool of stored files.

Most media players currently have an option to group and select media files by the media file's tag contents. Usually, the media file's title, artist, album, and genre identity are stored by the tags to allow media players to automatically search and categorize the files. A media file management program further allows users to select a combination of media files into a play-list file. The saved play-list is essentially a list of shortcuts (pointer to the directory path) of the media files stored within, and can be used by the media player instead of manually searching and selecting every desired media files each time the media player is executed. Each play-list can then be categorically stored by name. However, users are still required to remember the directory path where each play-list is stored. As a user creates more and more play-lists, remembering a desired play-list may not be easy, furthermore, skipping over an unwanted media file while playing a play-list still has to be done manually.

In order to solve the problems mentioned, there is a method available in the market in selecting favorite media files to generate a play-list. For example, U.S. Pat. No. 6,987,221 issued on Jan. 17, 2006 and entitled “AUTO PLAYLIST GENERATION WITH MULTIPLE SEED SONGS” provides a method for generating a play-list automatically. The method includes steps of: selecting one or more feed media files, the feed media files include desired media files and undesired media files; wherein the user can set a weight on each seed media file representing the importance level of each seed media file. Afterwards, the method compares each media file with each seed media file such that a media file can be analyzed and identified into a user defined preferred play-list. The play-list further allows manual edits by the user.

However, the above mentioned method requires manual inputs on the weight attributes on multiple seed files before the method can run comparison tests on each media files. These manual operations may be annoying and time consuming with no guarantee that the resulting selected media files would be tailored to a user's listening preferences.

Therefore, a heretofore unaddressed need exists in the industry to overcome the aforementioned deficiencies and inadequacies.

### SUMMARY OF INVENTION

During listening to music with a media player, a user generally increases volume output of the media player if the user prefers to a current playing music, and decreases the volume output of the media player if the user dislikes the current playing music. The volume output is the magnitude of sound. In order to solve problems as mentioned, the present invention provides a method and system for updating a weight value in a weight field of each media file based on the gain adjustment while the media files are played; and generating a play-list according to weight values thereof. The gain is an increase in signal power, voltage, or current by an amplifier, expressed as the ratio of output to input. The present invention makes the play-list more suitable to the user's listening preferences.

The method for generating a play-list of media files, each of the media files includes a tag for holding relative information about the media files. The method includes the steps of: setting a weight field in the tag for storing a weight value on the media file; setting a weight table for storing gain differences and their corresponding weight values; receiving a control command for adjusting a current gain value during the course of a media file being played; adjusting the current gain value according to the control command; obtaining an adjusted gain value; subtracting a referenced gain value by the adjusted gain value to obtain a gain difference; obtaining a weight value corresponding to the gain difference from the weight table; replacing the weight value in the weight field of the media file by the obtained weight value; receiving a control command for generating a play-list; obtaining the weight values in the weight field of each media file from the weight field thereof in response to the control command; and generating the play-list of the media files according to the weight values thereof.

The system for generating a play-list of media files, each of the media files includes a tag for holding relative information about the media files. The system includes a data storage unit, an input unit, a control unit and a file management unit. The data storage unit stores a weight table and the media files; the weight table stores gain differences and their corresponding weight values; the tag of each media file includes a weight field for storing a weight value on the media file. The input unit generates commands in response to operations of a user. The control unit identifies the commands during the course of a media file being played and performing a corresponding control command. The control commands include a gain adjustment control command and a play-list generation control command. The file management unit, under the control of the control unit, receives the gain adjustment control command during the course of the media files being played; adjusts the current gain value according to the gain adjustment control command; obtains a gain value being adjusted; subtracts a referenced gain value by the adjusted gain value to obtain a gain difference; obtains a weight value corresponding to the gain difference from the weight table; updates the weight value in the weight field of the media file; receives the play-list generation control command; obtains the weight values in the weight field of each media file from the weight field thereof in response to the play-list generation control command; and generates the play-list of the media files according to the weight values thereof.

Other systems, methods, features, and advantages will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF DRAWINGS

FIG. 1 is a schematic diagram of a user-interface of a media player in accordance with a preferred embodiment of the present invention;

FIG. 2 is a block diagram of hardware infrastructure of the media player of FIG. 1;

FIG. 3A and FIG. 3B are flowcharts of a first preferred method for generating a play-list and updating gain values in the weight field of each media file listed on the play-list in the media player of FIG. 2;

FIG. 4 is a schematic diagram of a first preferred embodiment representing a relationship between a gain difference and a weight value; and

FIG. 5 is a flowchart of a second preferred method for updating gain values in the weight field of each media file listed on the play-list.

### DETAILED DESCRIPTION

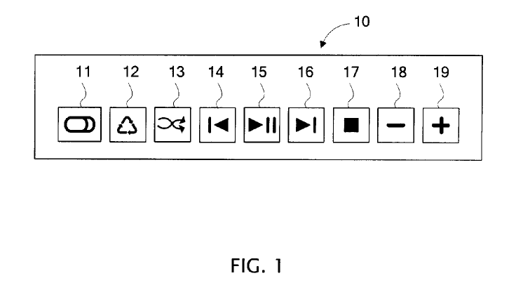

FIG. 1 is a schematic diagram of a user-interface of an media player such as a MP3 player in accordance with a preferred embodiment of the present invention. The media player 10 is user-controllable to skip forward (e.g., to next item), play a media file, pause a playing media file, skip backward (e.g., to previous item), activate/deactivate the media player 10, adjust the volume output of the media player 10, and the like. Accordingly, the media player 10 provides a user-interface for selecting these functions. The user-interface sets a plurality of buttons thereon, such as a skip forward button 14, a play/pause button 15, a skip backward button 16, a stop/power button 17, a decrease gain button 18, and an increase gain button 19. The user-interface further sets a play in order button 12 for playing selected media files in a predetermined sequential order, and a random play button 13 for playing the media files randomly. Moreover, the user-interface includes a locked button 11 for locking the buttons 12 to 19 thereby disabling the button functions therewith.

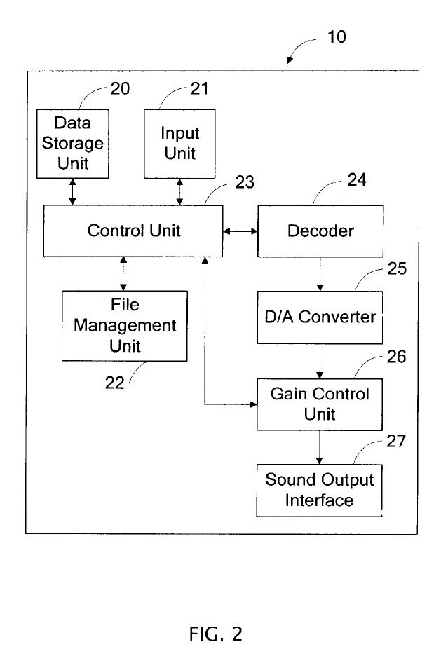

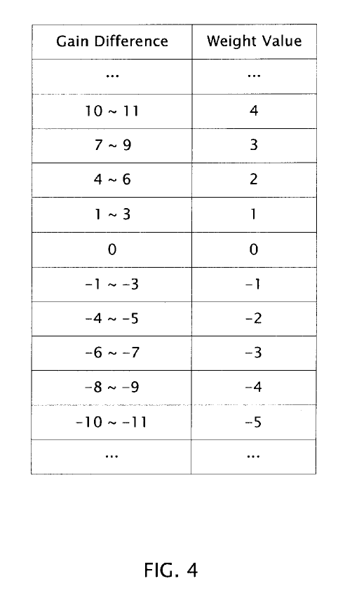

FIG. 2 is a block diagram hardware infrastructure of the media player of FIG. 1. The media player 10 includes a data storage unit 20, an input unit 21, a file management unit 22, a control unit 23, a decoder 24, a digital/analog converter 25, a gain control unit 26 and a sound output interface 27. The data storage unit 20 stores a plurality of media files, a default play-list, and one or more favorite index tables for indicating favorite media files of a user. Each of the media files is composed of a plurality of frames; a frame can be viewed as a small segment of the media file. Furthermore, each media file includes a tag for holding relative information of the media file. The relative information includes a weight value, and so on. Accordingly, the tag includes a weight field, and so on, to store the corresponding information. The weight values would indicate the user's preference level on a given media files. Furthermore, the data storage unit 20 stores a weight table for recording weight values and information associated therewith. The associated information may vary in different embodiments. For example, in a first embodiment, the associated information may involve gain differences such as that shown in FIG. 4. In a second embodiment, the associated information may involve gain differences and referenced gain values such as that shown in FIG. 6. The referenced gain values may be designated before playing media files, or may be automatically generated while playing media files. In addition, the data storage unit 20 can be a flash storage, a hard disk driver, and the like.

The input unit 21 includes a plurality of buttons (i.e., 11 to 19), thereby forming the user-interface of FIG. 1 to generate commands in response to operational inputs. The control unit 23 receives and identifies the commands from the input unit 21, and executes corresponding control commands to control the data storage unit 20, the file management unit 22, and the like. The control commands include a control command for generating a play-list (namely a play-list generation control command) and a control command for adjusting a current gain value (namely a gain adjustment control command).

When a gain adjustment control command is issued by the control unit 23 while the media files are played, the file management unit 22 adjusts the current gain value according to the gain adjustment control command; obtains a gain value being adjusted; subtracts a referenced gain value (described in detailed below) by the adjusted gain value to obtain a gain difference; obtains a weight value corresponding to the gain difference from the weight table (such as that shown in FIG. 4 or FIG. 6); updates the weight value in the weight field of the media file; receives the play-list generation control command; obtains the weight values in the weight field of each media file from the weight field thereof in response to the play-list generation control command; and generates the play-list of the media files according to the weight values thereof. The media files listed on the play-list may be from media files stored in the data storage unit 20, or may be from favorite media files indicated in the index table stored in the data storage unit 20.

The decoder 24 decodes the media file from a coded digital format into a readable digital format to be played. The digital/analog converter 25 converts the decoded digital media file to analog media signals. The gain control unit 26, under the control of the control unit 23, adjusts the current gain value for amplifying the analog media signals, according to the gain adjustment control command. The sound output interface 27 outputs the amplified analog media signals to an earphone or a speaker (not shown).

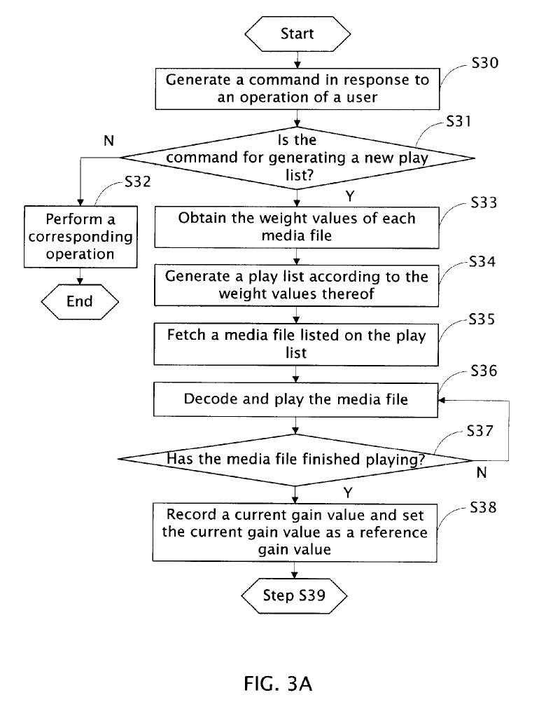

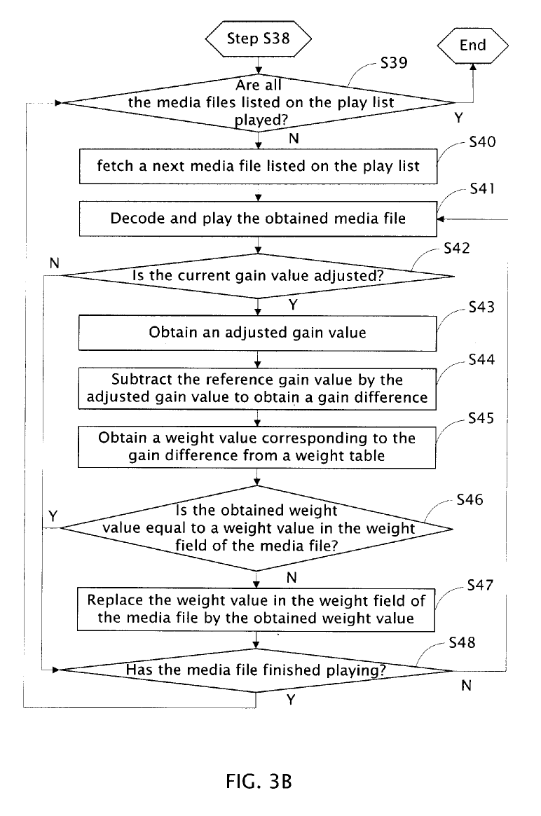

FIG. 3 (including FIG. 3A and FIG. 3B) is a flowchart of a first preferred method for generating a play-list and updating gain values in the weight field of each media file listed on the play-list in the media player of FIG. 2. In a power-off state of the medial player 10, a user selects the stop/power button 17 to activate the media player 10. In step S30, the input unit 21 generates a command in response to an input selection of the user, and sends the command to the control unit 23. In step S31, the control unit 23 determines whether the inputted command is for updating a default play-list, namely generating a new play-list. If the command is not for generating a new play-list, in step S32, the control unit 23 controls a corresponding unit to perform a corresponding operation according to the command, and the procedure is finished.

If the command is for generating a new play-list, in step S33, the control unit 23 controls the file management unit 22 to obtain the weight values in the weight field of each media file, and store the weight values in a temporary file. Thereby, in step S34, the file management unit 22 generates a play-list according to the weight values thereof. For example, the file management unit 22 rearranges all the media files stored in the data storage unit 20 according to the weight values, thereby generating a play-list therefrom. That is, the file management unit 22 orderly rearranges the media files according to the final weight values, or calls a random function, which employs the final weight values of the media files as a parameter, to randomly rearrange the media files. I.e., the media files having the greater final weight values would be more possible to be listed in the beginning portion of the play-list.

Furthermore, the file management unit 22 may also directly select a plurality of media files each of which has a weighted value being greater than a predetermined value, thereby generating another play-list therefrom. The file management unit 22 may also rearrange all the media files based on the weighted values in descending order, and selects a predetermined amount of media files on the top of the ordered list, thereby generating another play-list therefrom.

In step S35, the file management unit 22 fetches a media file listed on the play-list. In step S36, the decoder 24 decodes the media file from a coded digital form to a decoded digital form, the digital/analog converter 25 converts the digital media signals to analog media signals, the sound output unit 26 amplifies and outputs the analog media signals to an earphone or a speaker (not shown). In step S37, the file management unit 22 determines whether the media file has finished playing. If the media file has not finished playing, the procedure goes to step S36 to continually decode and play the media file. If the media file has finished playing, the file management unit 22 records a current gain value and sets the current gain value as a referenced gain value.

In step S39, the file management unit 22 determines whether all the media files listed on the play-list are played. If all the media files listed on the play-list are played, the procedure is finished. If any one media file listed on the play-list is not played, in step S40, the file management unit 22 fetches a next media file listed on the play-list. In step S41, the decoder 24 decodes the media file from a coded digital form to a decoded digital form; the digital/analog converter 25 converts the digital media signals to analog media signals; the gain control unit 26 adjusts a current gain value for amplifying the analog media signals; the sound output interface 27 outputs the amplified analog media signals to an earphone or a speaker (not shown).

In step S42, the file management unit 22 determines whether a current gain value is adjusted. If the current gain value is not adjusted, the procedure goes to step S48. If the current gain value is adjusted, in step S43, the file management unit 22 obtains the adjusted gain value. In step S44, the file management unit 22 subtracts the recorded referenced gain value by the adjusted gain value to obtain a gain difference. In step 45, the file management unit 22 obtains a weight value corresponding to the gain difference from the weight table as that shown in FIG. 4. In step S46, the file management unit 22 determines whether the obtained weight value is equal to a weight value in the weight field of the media file being played. If the obtained weight value is equal to the weight value in the weight field of the media file, the file management unit 22 maintains the weight value in the weight field of the media file, and the procedure goes to step S48. If the obtained weight value is not equal to the weight value in the weight field of the media file, in step S47, the file management unit 22 replaces the weight value in the weight field of the media file by the obtained weight value. In step S48, the file management unit 22 determines whether the media file has finished playing. If the media file has finished playing, the procedure goes to step S39. If the media file has not finished playing either, the procedure goes to step S41 to continually decode and play the media file.

FIG. 4 is a schematic diagram of a first preferred embodiment representing a relationship between a gain difference and a weight value. For simplicity, in such case, when the gain difference is between 10 and 11, the corresponding weight evalue is 4; when the gain difference is 0, the corresponding weight value is 0; when the gain difference is between −10 and −11, the corresponding weight value is −5. However, the relationship between the gain difference and the weight value may vary. That is, the relationship between the gain difference and the weight value can be set and adjusted.

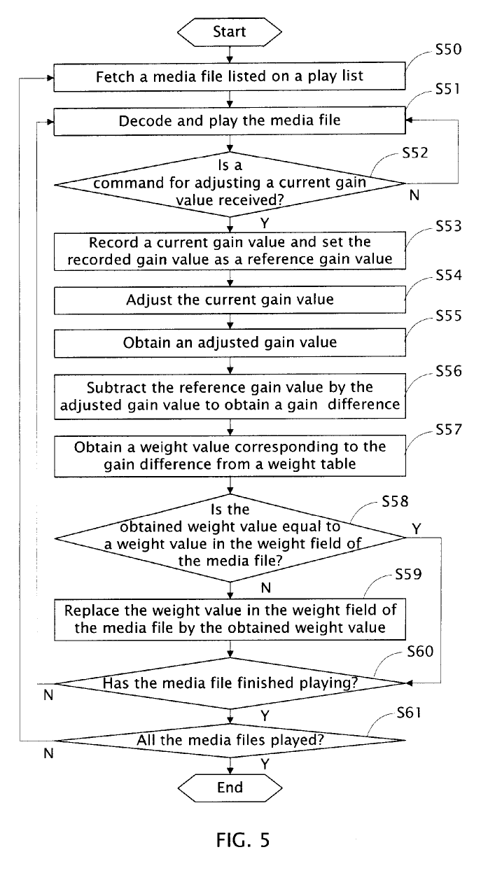

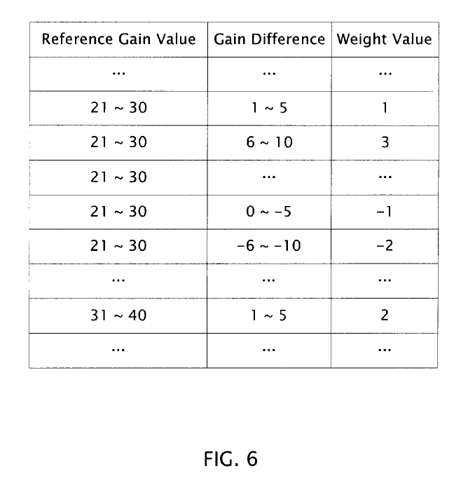

FIG. 5 is a flowchart of a second preferred method for updating gain values in the weight field of each media file listed on the play-list. In step S50, the file management unit 22 fetches a media file listed on the play-list. In step S51, the decoder 24 decodes the media file from a coded digital form to a decoded digital form; the digital/analog converter 25 converts the digital media signals to analog media signals; the gain control unit 26 adjusts a current gain value for amplifying the analog media signals; the sound output interface 27 outputs the amplified analog media signals to an earphone or a speaker (not shown). In step S52, the file management unit 22 determines whether a command for adjusting a current gain value is received from the input unit 21 via the control unit 23. If the command is not received, the procedure goes to step S51 to continually decode and play the media file. If the command is received, the file management unit 22 records a current gain value and sets the current gain value as a referenced gain value. In step S54, the control unit 23 controls the gain control unit 26 to adjust the current gain value in response to the command. In step S55, the file management unit 22 obtains an adjusted gain value. In step S56, the file management unit 22 subtracts the referenced gain value by the adjusted gain value to obtain a gain difference. In step S57, the file management unit 22 obtains a weight value corresponding to the gain difference from the weight table as that shown in FIG. 4.

In step S58, the file management unit 22 determines whether the obtained weight value is equal to a weight value in the weight field of the media file. If the obtained weight value is equal to the weight value in the weight field of the media file, the procedure goes to step S60. If the obtained weight value is not equal to the weight value in the weight field of the media file, in step S59, the file management unit 22 replaces the weight value in the weight field of the media file by the obtained weight value. In step S60, the file management unit 22 determines whether the media file has finished playing. If the media file has not finished playing, the procedure goes to step S51 to continually decode and play the media file. If the media file has finished playing, in step S61, the file management unit 22 determines whether all media files listed on the play-list are played. If all the media files are played, the procedure is finished. If any media file is not played, the procedure goes to step S50 to fetch a next media file listed on the play-list.

FIG. 6 is a schematic diagram of a second preferred embodiment representing a relationship between a gain difference and a weight value referring to the referenced gain value. For simplicity, in such case, when the referenced gain value is between 21 and 30 and the gain difference is between 1 and 5, the corresponding weight value is 1; when the referenced gain value is between 21 and 30 and the gain difference is between −6 and −10, the corresponding weight value is −2; when the referenced gain value is between 31 and 40 and the gain difference is between 1 and 5, the corresponding weight value is 2. However, the relationship between the gain difference and the weight value may vary. That is, the relationship between the gain difference and the weight value can be set and adjusted.

It should be emphasized that the above-described embodiments, including preferred embodiments, are merely possible examples of implementations, and are set forth for a clear understanding of the principles of the invention. Many variations and modifications may be made to the above-described embodiments without departing substantially from the spirit and principles of the invention. All such modifications and variations are intended to be included herein within the scope of this disclosure and the present invention, and be protected by the following claims.

What is claimed is:

1. A method for generating a play-list of media files, each of the media files comprising a tag for holding relative information about the media file, the method comprising the steps of:
setting a weight field in the tag for storing a weight value on the media file;
setting a weight table for storing gain differences and their corresponding weight values;
receiving a control command for adjusting a current gain value during the course of a media file being played;
adjusting the current gain value according to the control command; obtaining an adjusted gain value;
subtracting a referenced gain value by the adjusted gain value to obtain a gain difference;
obtaining a weight value corresponding to the gain difference from the weight table;
replacing the weight value in the weight field of the media file by the obtained weight value;
receiving a control command for generating a play-list;
obtaining the weight values in the weight field of each media file from the weight field thereof in response to the control command; and
generating the play-list of the media files according to the weight values thereof.

2. The method for generating a play-list according to claim 1, wherein the step of generating the play-list of the media files further comprises: rearranging all the media files according to the weight values, thereby generating the play-list therefrom.

3. The method for generating a play-list according to claim 1, wherein the step of generating the play-list of the media files further comprises: selecting one or more media files each of which has a weight value being greater than a predetermined value, thereby generating the play-list therefrom.

4. The method for generating a play-list according to claim 1, wherein the step of generating the play-list of the media files further comprises: rearranging all the media files based on the weight values in descending order, selecting a predetermined amount of media files on the top of the ordered list, thereby generating another play-list therefrom.

5. The method for generating a play-list according to claim 1, wherein the referenced gain value is predetermined.

6. The method for generating a play-list according to claim 1, further comprising step of: setting the current gain value when a first media file finished playing after being powered on as the referenced gain value.

7. The method for generating a play-list according to claim 1, further comprising step of: setting the current gain value before adjusting as the referenced gain value.

8. A system for generating a play-list of media files, each of the media files comprising a tag for holding relative information about the media files, the system comprising:
a data storage unit for storing a weight table and the media files, wherein the weight table stores gain differences and their corresponding weight values, the tag of each media file comprises a weight field for storing a weight value on the media file;
an input unit for generating commands in response to operational inputs;
a control unit for identifying the commands and performing corresponding control commands, wherein the control commands comprise a gain adjustment control command and a play-list generation control command; and
a file management unit, under the control of the control unit, for receiving the gain adjustment control command during the course of the media files being played; adjusting the current gain value according to the gain adjustment control command; obtaining a gain value being adjusted;
subtracting a referenced gain value by the adjusted gain value to obtain a gain difference; obtaining a weight value corresponding to the gain difference from the weight table; updating the weight value in the weight field of the media file; receiving the play-list generation control command; obtaining the weight values in the weight field of each media file from the weight field thereof in response to the play-list generation control command; and generating the play-list of the media files according to the weight values thereof.

9. The system for generating a play-list according to claim 8, wherein the file management unit further rearranges all the media files stored in the data storage unit according to the weight values, thereby generating the play-list therefrom.

10. The system for generating a play-list according to claim 8, wherein the file management unit further selects one or more media files each of which has a weight value being greater than a predetermined value, thereby generating the play-list therefrom.

11. The system for generating a play-list according to claim 8, wherein the file management unit further rearranges all the media files based on the weight values in descending order, selects a predetermined amount of media files on the top of the ordered list, thereby generates another play-list therefrom.

12. The system for generating a play-list according to claim 8, wherein the referenced gain value is predetermined.

13. The system for generating a play-list according to claim 8, wherein the file management unit further sets the current gain value of a first media file finished playing after being powered on as the referenced gain value.

14. The system for generating a play-list according to claim 8, wherein the file management unit further sets the current gain value before adjusting as the referenced gain value.
